(19) United States
(12) Patent Application Publication
(10) Pub. No.: US 2002/0154124 A1
(43) Pub. Date: Oct. 24, 2002

(54) System and method of enhanced computer user interaction

(76) Inventor: Sang-Yong Han, Seoul (KR)

Correspondence Address: COATS & BENNETT, PLLC, P O BOX 5, RALEIGH, NC, 27602, US

(21) Appl. No.: 09/791,126

(22) Filed: Feb. 22, 2001

(51) Int. Cl. G06T 13/00

(52) U.S. Cl. 345/473

(57) ABSTRACT

A character agent resident on a user's computer facilitates interaction with the computer. The character agent provides character animation, text balloons, menus, and speech input/output. The character agent may operate based on locally stored supporting files, and may significantly extend its flexibility with supporting files retrieved dynamically, such as during Internet browsing. In this latter context, the character agent greatly extends the opportunity for interaction between various Internet sites and the user. A character server, which may be the web server, downloads a Character Action Markup Language (CAML) document and supporting animation files. These files specify the animation and behavior of the character agent. A browser plug-in allows the character agent to respond to browser events according to the CAML document's instructions. The character agent may automatically retrieve supporting files when provided with an active Internet connection, and may also be driven via a remote server using two-way scripting.

### BACKGROUND OF THE INVENTION

The present invention generally relates to computer systems, and particularly relates to enhancing communication and interaction with a computer user.

The Internet has made available to its users information in a quantity and variety previously unimaginable. Millions of web sites or pages are available, and that number increases exponentially with each passing year. Where a few short years ago, only select businesses maintained publicly accessible web sites, commercial and entertainment web sites are now ubiquitous. Indeed, there are few remaining companies and organizations that have not established some form of web presence, however modest.

In a basic sense, a web site's purpose involves, in some fashion, the transfer of information from the site to a remote user accessing the site via the Internet. The term “browsing” is broadly applied to the activity of visiting one or more web sites, and derives from the “browser” application that provides users with a common interface to the Internet. Browser programs receive and interpret information from remote web servers and generate local display information based on the received data. Perhaps the most basic Internet file type is the HTML file or page, which provides for formatted text and pictures that are transmitted from the web site to the user's computer, where they are formatted for local display by the browser. The browser also permits interaction with the remote web server by recognizing when the user interacts with the displayed page.

With the advent of so-called “active content,” such as Microsoft's Active-X and Java Applets, web pages are more enticing and flexible now than in the past. However, such enhancements are not able to fully overcome the underlying static nature of web pages. Simply put, the basic premise of browsing is that a user will visit a web page, perhaps peruse it for something interesting, using the listed contents of the page as a guide. If nothing catches the user's eye, the user will likely leave the site in search of something more interesting.

This leaves the person, company, or organization sponsoring the site at something of a disadvantage. The web site might be constructed so that the top-level page, the page normally displayed first to the user, described all that was interesting or new about the site. However, this approach risks making the initial page jumbled or overwhelming to the user by sheer dint of available choices. The web site might also provide selected banners affording prominent display of the site's most popular or important features. However, this approach also has its disadvantages.

More generally, the interface between a computer and its user consists primarily of menus and specific keyboard commands that may change from application to application. Few programs extend the user interface to include more intuitive mechanisms for interacting with users, even within graphical operating systems capable of providing such mechanisms in a relatively straightforward manner.

### BRIEF SUMMARY OF THE INVENTION

A system and method provide enhanced communication between web sites and computer users. Software acting as an agent process running on a user's computer system provides the user with a character interface that behaves in accordance with specified behavior information contained in downloaded behavior files or scripts, or stored as preexisting information on the user's computer. The character interface provides assistance and enhances communication with the user through animation sequences, helpful gestures, a content viewer, sound effects, balloon text, as well as speech input and output.

The agent process may use an associated web browser plug-in or extension to alert the agent process when the user visits a web site that provides support for the agent process. When this happens, the plug-in receives the address of a “character server” from the supporting web site. The character server, which may be the web server, holds behavior files and associated animation sequence files that are relevant to the services or features of the associated web site. This provides an opportunity for enhanced communication and interaction with the user via the character interface. The agent process uses the received address to access the character server and download these supporting files. The behavior file, which may be a Character Action Markup Language (CAML) document, determines which browser events the agent process will respond to, as well as the specific actions taken in response to those events.

The agent process may also retrieve data from one or more character servers, each possibly associated with a different web site or organization, automatically when the user's computer is connected to the Internet, even without the user actually visiting the web sites associated with the character servers. In this manner, the various web sites may communicate with or interact with the user via the agent process and its associated character interface. This may be useful, for example, to alert the user to special events, sales, or site updates, thereby enticing the user to visit the web site. The various character servers with which the agent process communicates may provide, for example, two-way scripts that allow interactive communication with or support of the user via the character interface.

The agent process may also operate off-line, without benefit of an active network or Internet connection. In this manner, the agent process might utilize previously stored or installed behavior files, as well as other supporting files. The agent process may provide support to the user by executing functions within available library files, such as dynamic link library (DLL) files. For example, the user may click or otherwise interact with the character interface and the agent process, in response, may execute one or more program functions that are associated with the specific user interaction. In all cases, the behavior files defines interactive behavior of the character interface by defining the actions and reactions taken by the agent process with regard to the character interface.

### BRIEF DESCRIPTION OF THE DRAWINGS

FIG. 1 is a diagram of an exemplary environment for practicing the present invention.

FIG. 2 is a diagram of an exemplary arrangement for the computer system of FIG. 1.

FIG. 3 is a functional diagram of the computer of FIG. 2.

FIG. 4 is an exemplary functional diagram of the agent program in accordance with the present invention.

FIG. 5 is a diagram of the relationship between the modules of the agent program and the computer system of FIG. 2.

FIG. 6 is a diagram of the web service mode of the agent program.

FIGS. 7A and 7B are diagrams of exemplary flow logic for the web service mode of the agent program.

FIG. 8 is a diagram of the two-way service mode of the agent program.

FIG. 9 is a diagram of exemplary flow logic for the two-way service mode of the agent program.

FIG. 10 is a diagram of the local service mode of the agent program.

FIG. 11 is a diagram of exemplary flow logic for the local service mode of the agent program.

FIG. 12 is a diagram of an exemplary character file providing animation information for animating the on-screen character provided by the agent program.

### DETAILED DESCRIPTION OF THE INVENTION

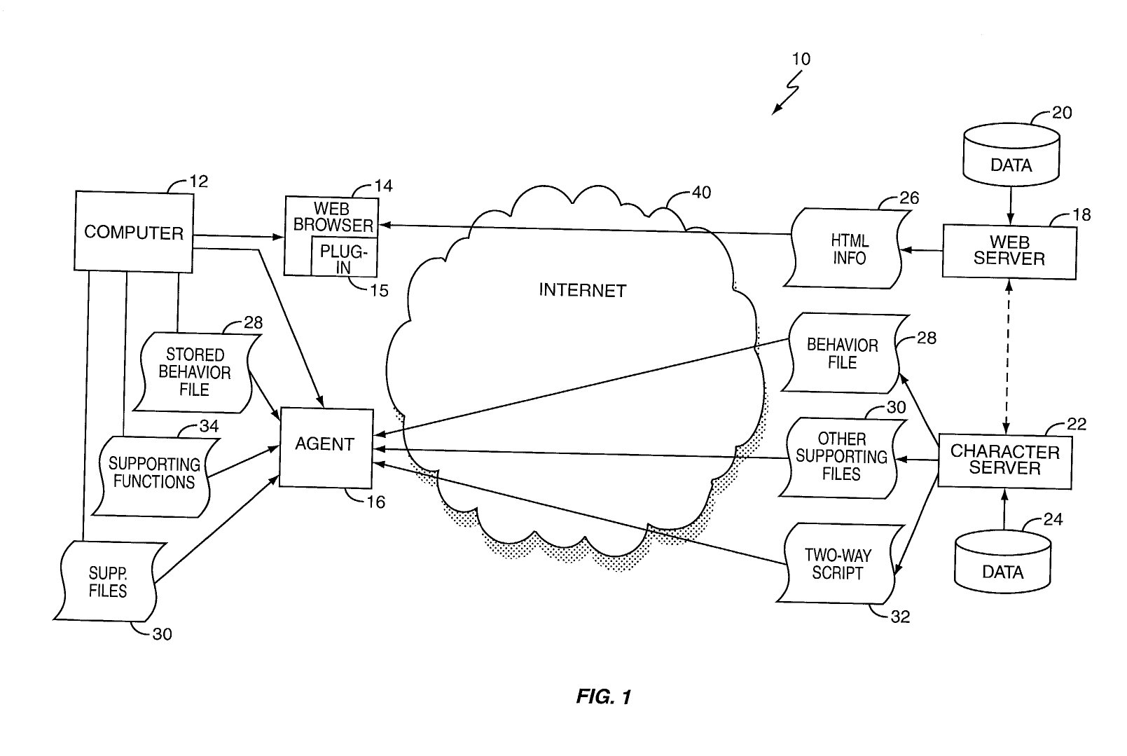

Turning now to the drawings, FIG. 1 is a diagram of an exemplary environment for practicing the present invention, generally referred to by the numeral 10. A computer 12 runs a web browser application (browser) 14, preferably with a plug-in 15, as well as an agent program (agent) 16. The agent 16 may operate independently from the browser 14, or in conjunction with the browser 14, using the plug-in 15 as an interface between the two. The agent 16 enhances interactivity and communication between the computer 12 and a user, and may, among other things, facilitate web browsing.

The browser 14 receives web site information, such as HTML pages 26, from a web server 18 having associated data 20. The agent 16 receives agent-related files from a character server 22 having associated data 24. The supporting files typically include a behavior file 28, other supporting files 30, and, possibly, two-way script files 32. The character server 22 is typically associated with one or more particular web sites hosted by the web server 18. Thus, in one mode of operation, the character server 22 provides the agent 16 with information that it uses to enhance communication with the user of the computer 12, while that user is browsing with on one of the associated web sites hosted by web server 18.

Note that the character server 22 provides dedicated storage for the supporting files used to support operation of the agent 16 at the computer 12. In this way, an organization may provide one or more animated presentations, or other interactive agent routines packaged as sets of supporting files for retrieval by computer systems 12 having installed agents 16. Thus, the agent 16 represents a flexible, customizable mechanism for conveying substantial information to a user of the computer system 12, on an interactive basis. As specified earlier, the character server 22 may be the web server 18, but in any case provides the necessary dedicated storage for the agent's supporting files.

In other modes of operation, the agent 16 provides support to the user of the computer 12 independent of the browser 14, and, in some local modes, independent of the character server 22. In these local modes, the agent 16 utilizes locally stored files, including a locally stored behavior file 28, other supporting files 30, as well as supporting functions 34. These various modes of operation, along with more particular details about the operation of the agent 16, are explained in more detail later. Also worth noting, the character server 22 and the web server 18 are illustrated as separate systems, each accessible to the computer 12 via the Internet 40. While in practice, this implementation may yield greater flexibility, the web server 18 and the character server 22 may be implemented together as a single system or entity.

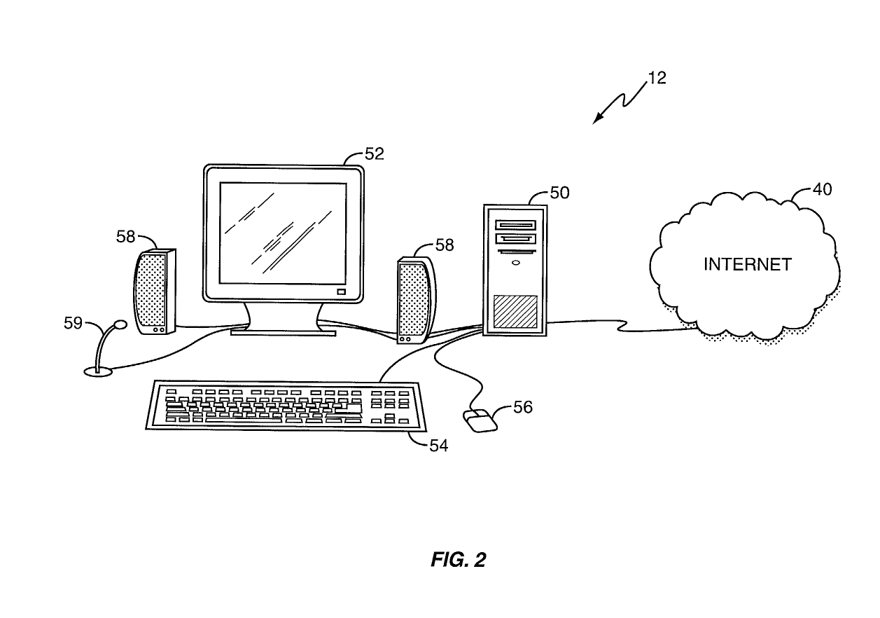

FIG. 2 is a diagram of the computer 12. The computer 12 comprises a system unit 50, a display 52, a keyboard 54, a mouse 56, speakers 58, and a microphone 59. Minimal implementations of the computer 12 may forego, for example, the speakers 58 and microphone 59, favoring cost savings and simplicity at the expense of audio interaction with the agent 16. The computer 12 may be altered in other ways, incorporating greater or fewer supporting components as needed or desired.

While the agent 16 is discussed in the context of the computer 12 as shown in FIG. 2, it should be understood that the agent 16 may be implemented in software compatible with a number of different computing platforms or computing devices. This may be particularly relevant, given the increasing sophistication of portable digital assistants (PDAs), as well as other hand-held computing devices. Indeed, the agent 16 may be modified to expand or restrict the way in which it communicates with a user, based on the underlying capabilities of the platform or device on which it is running.

Thus, in the context of this disclosure, the term “computer” embraces the gamut of computing devices, from standard desktop PCs, laptops, palm computers, and other handheld devices. It should be understood that the agent 16 is readily adapted to this wide variety of computing devices.

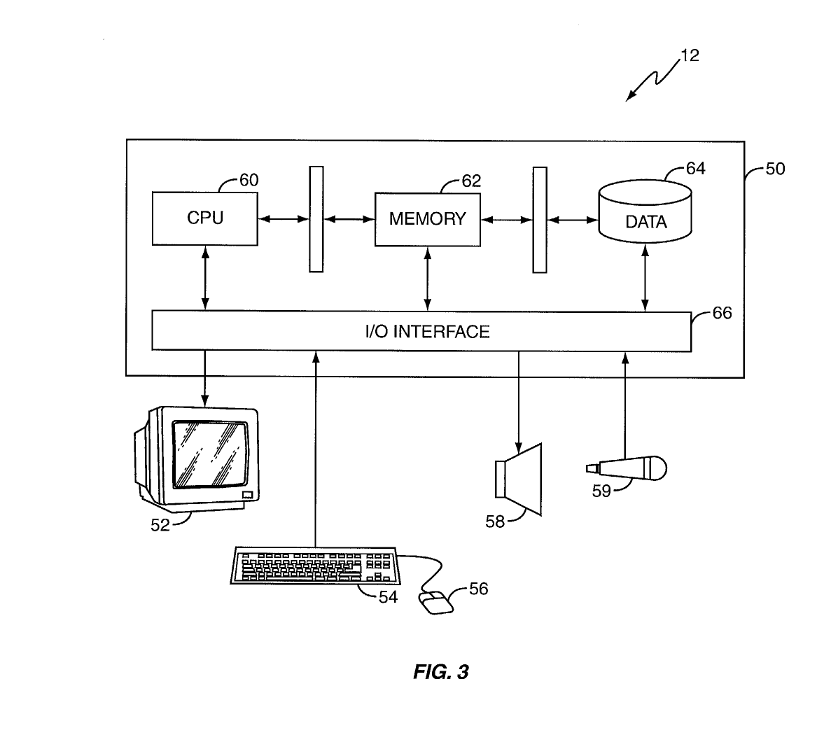

FIG. 3 is a functional diagram of the computer 12, and illustrates how its various elements cooperate. The system unit 50 comprises a central processing unit 60, memory 62, a hard disk 64, and an I/O interface 66. The display 52, keyboard 54, mouse 56, speakers 58, and microphone 59, all interface to the system unit 50 via the I/O interface 66. Note, this functional diagram is necessarily simplified and may not represent specific architectural details in an actual computer implementation. For example, the computer 12 may incorporate a Universal Serial Bus (USB) to interface the system unit 50 with one or more external peripherals (e.g., the keyboard 54, etc.). Other variations will exist depending upon system platform and intended operating system (e.g., Intel/Windows, Sparc/Solaris, PowerPC/Apple, etc.).

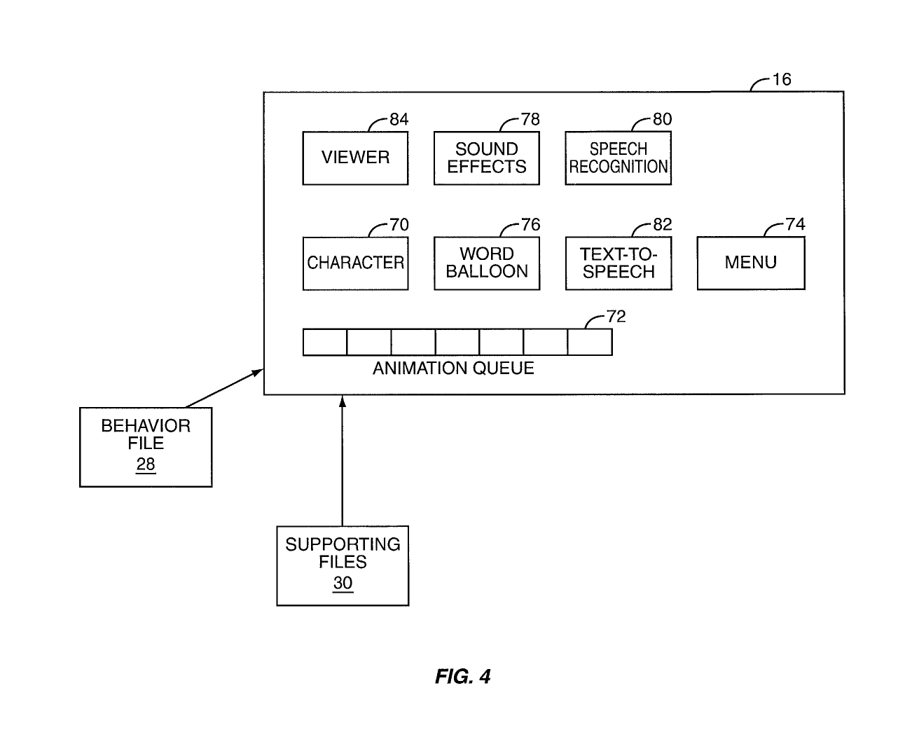

FIG. 4 is a diagram of the agent 16. The agent 16 may be referred to as an intelligent character agent, or ICAgent, because of its ability to intelligently interact with or convey information to a user of the computer 12. Implementation of the agent 16 is subject to much variation, but in this exemplary organization, the agent 16 comprises a number of components or “modules.” The agent 16 may include but is not limited to a character module 70, with its associated animation queue 72, a menu module 74, a word balloon module 76, a sound module 78, a speech recognition module 80, and a text-to-speech module 82.

Some or all of these modules may be implemented as library functions installed on the computer 12 to provide access to supporting system features, or to provide interfaces to selected operating system features. For example, the various modules of the agent 16 may be implemented as one or more dynamic link library (DLL) files. Of course, the agent 16 may be organized as a composite program that provides the features of one or more of the above modules.

The character module 70 provides a character interface on the display 52 of the computer 12. The appearance of the character interface may be set by graphic files downloaded from the character server 22, as part of the supporting files 30. Graphic files may also be stored locally on the computer 12. The agent 16 may load a desired set of graphic files from the supporting files 30 into its animation queue 72 to generate a specific animation sequence for the character interface provided by the character module 70. Thus, agent 16 may be configured via the behavior file 28 or two-way script 32 to provide specific animation sequences keyed to selected user actions at the computer 12. For example, the agent 16 might play an introductory animation sequence using the character interface provided by the character module 70 when the user of the computer 12 first visits a web site associated with the web server 18.

The character interface provided by the character module 70 is responsive to user input. For example, the character module 70 may respond to the user clicking on the character interface, or may support the user dragging the character interface to a desired location on the display 52. When not providing information to the user or not responding to user interaction, the character module 70 may cause the character interface to run through one or more animation sequences associated with the “idle” state.

Interaction between the user and the character interface may be further supported, for example, by the display of one or menus. The menu module 74 may generate one or more menus or menu items that are selectable by the user 12 via, for example, the mouse 56. The specific menu or menu items displayed may change with the changing context of the user's activities. For example, the menu items displayed may change as the user browses different web pages available on the web server 18. Information about the desired menu structures, as well as specific menu text may be provided as part of the supporting files 30.

The agent 16 may use the behavior file 28 to determine the appropriate response to the user selecting a specific menu item. That is the behavior file 28 may contain specific instructions for actions to be taken by the agent 16 for all defined menu choices. Alternatively, this same functionality can be provided via the two-way script 32. This might be appropriate when the agent 16 provides menu choices to the user independent of the user visiting any web sites associated with the web server 18.

The word balloon module 76 allows the agent 16 to create cartoon-like word balloons that may be displayed in conjunction with the character interface provided by the character module 70. In this manner, communication with the user may be supplemented with balloon text that may be made context sensitive with regard to the user's activities. For example, when the user is browsing a web site associated with the web server 18, balloon text may be displayed alerting the user to specific features or promotions available through the current web page. The two-way script 32 might also define text for creating a series of interactive text balloons that provide information about web site updates, promotions, sales, etc., even if the user does not access the web server 18.

User interaction may be further enhanced with the sound effects module 78, the speech recognition module 80, and the text-to-speech module 82. Any or all of these modules may exploit the audio features providing by the operating system of the computer 12. For example, in a Microsoft® Windows environment, the sound effects module 78 may use the Win32 Application Programming Interface (API) function “PlaySound” that plays a sound specified by the given filename.

The supporting files 30 can include sound files, such as “WAV” files, and the behavior file can specify which sound file to play in a given circumstance, or upon a given user interaction with the agent 16. The behavior file 28 may also specify certain default sound files that may be expected to reside on the user's machine, such as the standard Windows sound files used by the operating system in a default installation.

Similarly, the speech recognition module 80 and the text-to-speech module 82 may use Microsoft's Speech API (SAPI) to implement voice input and output functions. These functions extend the interactivity between the user and the computer 12, and provide an opportunity for remote organizations affiliated with the web server 18 and character server 22 to guide, support, or inform the user 12 in an intuitive, convenient manner. For example, when the computer 12 connects to the Internet 40, the agent 16 may seek out one or more character servers 22 to receive current information relating to the web sites or organizations associated with the one or more character servers 22. The agent 16 may then use any or all of its interactive features to communicate the information to the user, possibly inviting the user to visit one or more of the associated web sites.

The viewer module 84 provides a viewer or viewing window on the display 52 that may be used to show various web contents, including desired web pages, streaming media, or other content. The viewer module 84 may provide the user with an opportunity to select a desired “skin,” which imparts a defined appearance to the viewer. These skins may be downloaded or pre-installed on the computer 12 as part of the supporting files 30. The viewer module 84 provides a mechanism for one or more character servers 22, or associated web servers 18, to provide desired web content to the user via the agent 16.

With the above structure for the agent 16 in mind, the supporting files 30 may be further discussed. In general, the supporting files 30 can include but are not limited to the following files, or sets of files:

Animation files (e.g., one or more Graphics Interchange Format (GIF) files)

Sound files (e.g., one or more WAV files)

Text-to-speech files (e.g., one or more desired text strings)

Menu files (e.g., one or more files defining menu structure and choices)

Word balloon files (e.g., one or more files defining desired word balloon text)

These files may be downloaded or updated from supporting character servers 22 via the Internet, and may also be included as part of the initial installation of the agent 16 on the computer 12.

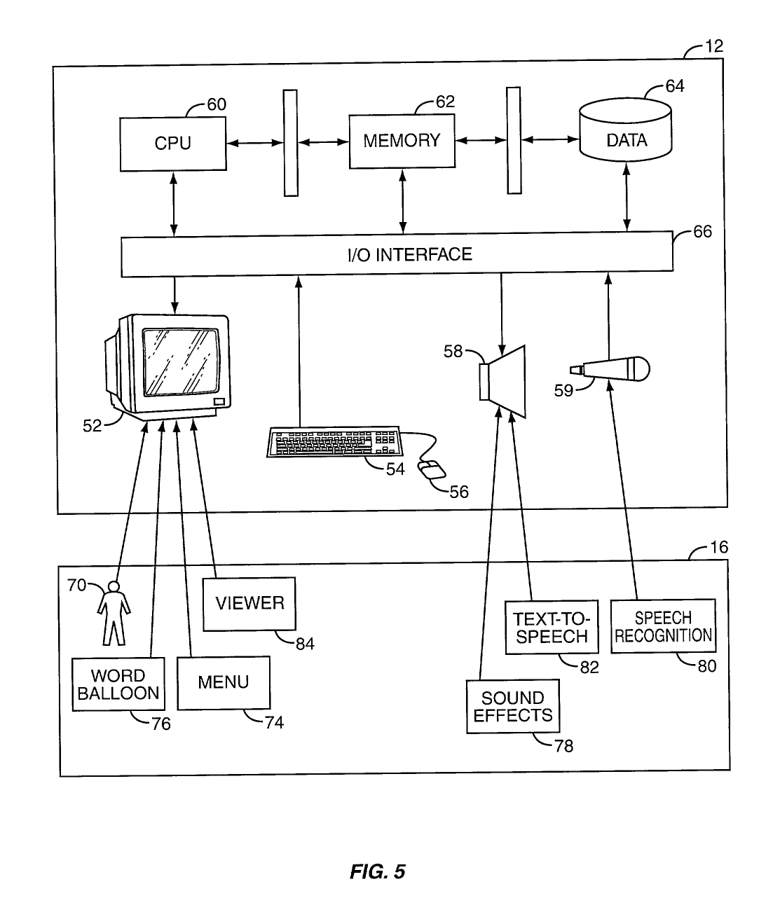

FIG. 5 is diagram illustrating the relationship between the various modules of the agent 16 and the computer 12. The agent 16 is typically installed on the hard disk 64 of the computer 12 and, when running, resides wholly or partly in the memory 62 and CPU 60. The visually-related modules, including the character module 70, the menu module 74, the word balloon module 76, and the viewer module 84, generate or coordinate visual output for the display 52. Note also, that these visually related modules may also provide interaction with the user via the keyboard 54 and the mouse 56.

The audio-related modules, including the sound effects module 78, the speech recognition module 80, and the text-to-speech module 82, use the audio systems, such as the speakers 58 and the microphone 59, of the computer 12. Note that the computer 12 may incorporate audio equipment, such as a standard sound card (not shown), to manage the electrical interface between the system unit 50 and the speakers 58 and the microphone 59.

As introduced earlier, the agent 16 in general provides three different modes of operation. These three modes are not mutually exclusive, and the agent's operation may be hybrid of these modes. First, the agent 16 may provide enhanced interaction between web sites associated with one or more web servers 18 while the user is actively browsing those sites via the browser 14. Second, the agent 16 may provide interaction or communication with the user any time the computer 12 has an active Internet connection, based on the agent 16 communicating with one or more character servers 22. Third, the agent 16 may provide interaction or communication with the user in a stand-alone fashion, independent from any connection to the Internet. The above modes are referred to as the “web service” mode, the “two-way service” mode, and the “local” service mode, respectively.

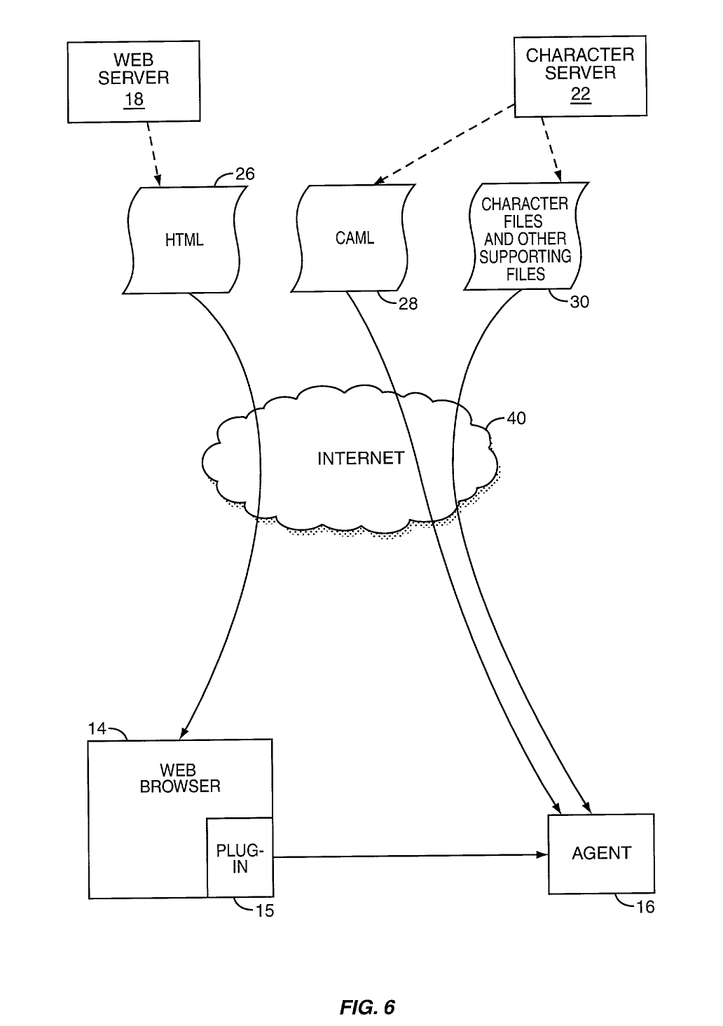

FIG. 6 is a diagram of the web service mode of operation for the agent 16. The user activates the web browser 14 and establishes a connection between the computer 12 and the Internet 40. The user accesses a web site that supports the agent 16 on the web server 18. The web site provides site information, typically in the form of a HTML web page 26 that includes notifying information, such as a defined tag. The browser 14 includes the plug-in 15 supporting its interaction with the agent 16. Upon receiving the notifying information from the web server 18, the plug-in 15 initiates or alerts the agent 16. Note, in this context, the term “plug-in” is generic and encompasses browser add-in or applets, and applies equally to different browsers, including Netscape® Navigator and Microsoft® Internet Explorer.

The plug-in 15 works to keep the agent 16 apprised of the current state of the browser 14. That is, the plug-in 15 serves as a communication conduit between the web browser 14 and the agent 16. The plug-in 15 provides event notifications related to the web browser 14. For example, the plug-in 15 may alert the agent 16 when the user opens a new HTML document (web page), reloads a current HTML document, clicks a web page picture or hyperlink, or moves the mouse pointer over one or more regions of the HTML page displayed by the browser 14.

The agent 16 responds to these events based on behavior information contained in the behavior file 28, or in the two-way script 32. That is, the behavior information defines the actions or events to which the agent 16 will respond, and defines the particular actions taken by the agent 16 in response to the different events.

The behavior file 28 may be a Character Action Markup Language (CAML) file. CAML provides the flexibility and extensibility to character animation functions provided by the agent 16 that HTML files provide to the browser 14. CAML documents are constructed similarly to the HTML format that enables broad compatibility between web browsing software and disparate types of web servers.

A CAML document defines all character actions for the agent 16, and may include: user-specific information, an animated character name, menu creation information, menu item handlers and event handlers. Menus handlers define animated character actions, so the agent 16 may respond with the appropriate action, such as a desire animation sequence, when the user selects a particular menu item. The following item list provides a detailed definition of a CAML document:

The CAML element

Start tag: required, end tag: required

All of a CAML document is contained within a CAML element.

The HEAD element

Start tag: required, end tag: required

The HEAD element contains information about the current CAML document, such as its user-specific information, which may represent customer information or data, character information, menu hierarchy, and automatic two-way items.

The BODY element

Start tag: required, end tag: required

The body of a document contains the document's contents. The content may describe or define operations of agent 16 for specific events or situations.

The SP element

Start tag: required, end tag: required

A service provider element describes customer's information: the name attribute specifies the user or customer's name for the current document, the address attribute specifies address of the supporting character server 22 for downloading character animation files and other supporting files 30, and the character attribute specifies a default character's name for the animated character interface provided to the user by the agent 16.

The CHARACTER element

Start tag: required, end tag: required

A character element describes the animated character's information: the name attribute specifies the current character's name and the source attribute specifies address of the character server 22 for downloading the supporting files 30, including animation sequences and other character action files.

The MENU element

Start tag: required, end tag: required

The menu element contains the menu hierarchy information of the current document.

The TOW-WAY element

Start tag: required, end tag: required

The two-way element contains all of the automatic two-way items used by the agent 16 in the two-way service mode.

The ENTRY element

Start tag: required, end tag: optional

An entry element describes menu information: caption attribute specifies menu content and ID attribute specifies menu identifiers.

The ITEM element

Start tag: required, end tag: optional

An item element describes two-way item information: the ID attribute specifies a two-way items identifier, the post attribute specifies an address of the two-way item for requesting from it from the character server 22, the post data attribute specifies arguments of the post attribute, the start time specifies the beginning time of automatic two-way operation, finish time specifies the ending time of automatic two-way operation, and frequency attribute specifies a period of automatic two-way operation for the agent 16.

The ONSTART element

Start tag: required, end tag: required

The ONSTART element contains agent operations that are invoked when the current CAML document is loaded by the agent 16, such actions might include character animation sequences for the animated character provided to the user on the display 52 by the character interface module 70.

The ONMASTER element

Start tag: required, end tag: required

The ONMASTER element contains a character action list describing character actions or animations that are played upon refreshing the current CAML document.

The ONMENU element

Start tag: required, end tag: required

The ONMENU element contains services or identifies actions taken by the agent 16 when the user selects a corresponding menu item.

The ONEVENT element

Start tag: required, end tag: required

The ONEVENT element contains animated character actions or other agent operations that are activated for specific web browser events.

The WORK element

Start tag: required, end tag: required

A work element describes the manner in which the agent 16 animates or controls the animated character it provides to the user, and defines the way in which character animation sequences are played. The work element includes: and ID attribute that specifies a menu ID, and a type attribute that specifies the type of corresponding operation or action taken by the agent 16.

The HANDLER element

Start tag: required, end tag: required

A handler element describes what character animation to play, or other agent action to take, when the agent 16 receives notification of a corresponding browser event. The handler element includes an ID attribute that corresponds to one or more event identifiers used by the plug-in 15 to identify specific browser events.

The DOACTION element

Start tag: required, end tag: required

A DoAction element describes an animated character action list that defines an action or actions taken by the agent 16. The DoAction element includes: a char attribute that specifies the animated character's name, a name attribute that specifies one or more actions, and one or more additional attributes capable of supplying arguments, if needed, for the specified action.

The DOTWOWAY element

Start tag: required, end tag: required

A DoTwoWay element describes an address of a desired two-way script that the character server 22 will return to the agent 16. The DoTwoWay element may include post data and post data attributes that specify the address, and may provide additional information to the agent 16 regarding the involved two-way script 32.

The DOLOCAL element

Start tag: required, end tag: required

A DoLocal element describes an exported function within a DLL file that the agent 16 may import and call (use). The DoLocal element includes a DLL attribute that specifics the corresponding DLL file's name, while a function attribute specifies the particular function within the named DLL file.

The following text provides an example of the “head” portion of a CAML document in accordance with the above structure listing:

<CAML>
<HEAD>
<SP name=postech nonclient=www.postech.ac.kr
address=http://www.icagent.com/icagent/ char=yani></SP>
<CHARACTER name=yani source =www.icagent.com></CHARACTER>
<MENU>

<ENTRY caption=Weather id=weather.
<ENTRY caption=News id=news>
<ENTRY caption=Speak id=speak>
<ENTRY caption=WebThink id=think>

</MENU>
<TWOWAY>

<ITEM id=news post=http://autotwoway.icagent.com/php/news.php

PostData=“id=hsko” StartTime=“1:00” Finish Time=“23:00” frequency=4m>

<ITEM id=weather post=http://autotwoway.icagent.com/php/weather.php

PostData=“id+hsko” StartTime “1:00” FinishTime=“23:00” frequency=4m>
</TWOWAY>
</HEAD>

Similarly, the following example illustrates a body portion of a CAML document in accordance with the earlier structural description:

<BODY>
<ONSTART>

<DOACTION>

<ACTION char=yani name =show>

</DOACTION>

</ONSTART>
<ONMASTER>

<DOACTION>

<ACTION char=yani name=show>

</DOACTION>

</ONMASTER>
<ONMENU>

<WORK id=news type=twoway>

<DOTWOWAY post=http://sendtwoway.icagent.com/php/news.php

postdata=“id=hsko”>

</WORK>
<WORK id=speak type=action>

<DOACTION>

<ACTION char=yani name=show strArg 1=true>
<ACTION char=yani name=speak strArg 1=“hello”>
<ACTION char=yani name=play strAgr 1=congraturate>
<ACTION char=yani name=present strArg

+http://www.yahoo.com
numarg 1=1 numarg2=10>

</DOACTION>

</WORK>
<WORK id=local type=local>

<DOLOCAL dll=news function=today>

</WORK>

</ONMENU>
<ONINPUT>
</ONINPUT>
<ONEVENT>

<HANDLER id=1>

<DOACTION>

<ACTION char=yani name+show strArg 1+false>
<ACTION char=yani name=think strArg 1=“Zzzz...”>

</DOACTION>

</HANDLER>
<HANDLER id=2>

<DOACTION>

<ACTION char=yani name=show strArg 1=false>
<ACTION char=yani name=think strArg 1=“Zzzz...”>

</DOACTION>
</HANDLER>

</ONEVENT>
</BODY>
</CAML>

In general, the agent 16 provides two types of presentations associated with web browsing activities. These two types of presentations are referred to as “full” and “spot” presentations. The agent 16 typically performs a full presentation when the user opens or reloads a web page via the browser 14. The agent 16 may be configured to control whether or not reloading pages triggers subsequent full presentations. The <ONSTART>tag of the supporting CAML document, or related provision in a behavior file 28 of another format, identifies the loading or reloading actions that should be undertaken by the agent 16.

Spot presentations correspond to the specific action or actions taken by the agent 16 in response to receiving event notifications from the plug-in 15. When the agent 16 receives an event notification from the plug-in 15, it determines whether or not the behavior file defines a desired response for that event. If so, the agent 16 executes the instructions defining the desired response, and this action is referred to as a spot presentation. The behavior file 28 defines which events the agent 16 handles by including event handlers for each type of event for which an agent response is desired. The handler tags defined in the CAML document format above are an example of such handlers.

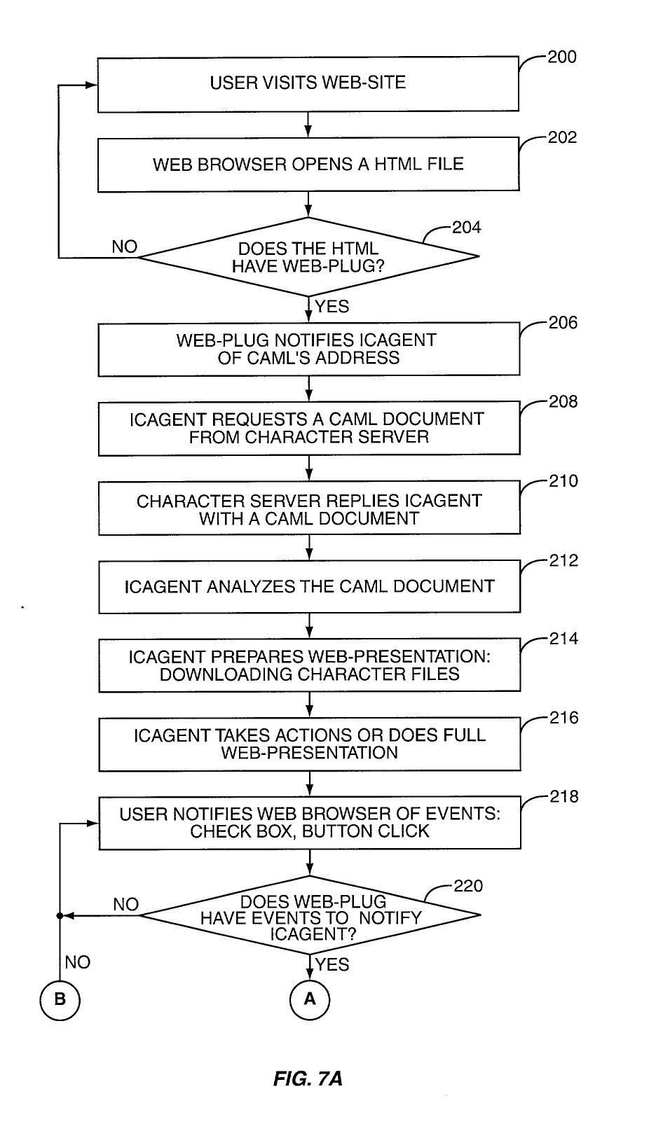

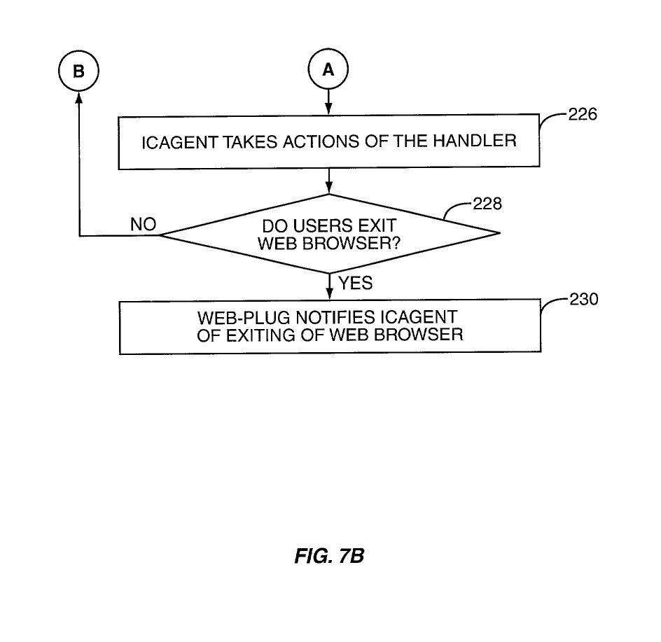

FIGS. 7A and 7B diagram exemplary flow logic for the web service mode provided by the agent 16, as discussed earlier. Processing begins with the user of the computer 12 visiting a web site provided by the web server 18 (block 200). The web browser 14 opens an HTML file 26 (block 202), and determines whether or not the HTML file 26 includes an agent tag, or other form of notifying information indicating support for the agent 16 (block 204).

If the site information indicates support for the agent 16, the plug-in 15 notifies the agent 16 of the address of the associated character server 22, the address information being included with the other site information (block 206). As noted, the character server 22 may actually be the web server 18. In that case, the web server 18 includes the behavior file 28, along with the other supporting files 30. If the web site does not indicate support for the agent 16, the processing returns to a waiting condition in anticipation of the user visiting a site that does provide support (block 200).

Once the agent 16 receives the character server's address, it requests the behavior file 28 (e.g., a CAML document) (block 208). The character server 22 provides the behavior file 28 to the agent 16 (block 210), and the agent 16 analyzes the received file to determine the appropriate configuration for its various modules (e.g., character module 70, etc.) (block 212). Typically, the agent 16 prepares an initial web presentation for the user, upon the user first opening an HTML page 28. In preparation for this presentation, the agent 16 retrieves the various supporting files 30 from the character server 22, if such files are not already stored on the computer 12, or if such locally stored supporting files 30 are outdated (block 214).

Once the supporting files 30 are retrieved or updated, the agent 16 takes the appropriate action, which may be a presentation of features available at the web site based on running one or more animation and sound or speech sequences (block 216). After the initial presentation, the agent 16 may wait on further interaction between the user and the web page displayed by the browser 14 (blocks 218 and 220). Specifically, the plug-in 15 remains responsive to user interactions, such as mouse clicks or movements, or keyboard commands (block 218).

If there are any browser events (block 220), the plug-in notifies the agent 16 of the particular event or events (block 222), and the agent 16 determines the appropriate action to take based on instructions in its behavior file 28 (block 224). These instructions may be event handlers that identify appropriate actions for the agent 16 based on the type of event, and the specific context of the event. That is, the plug-in 15 may provide event arguments detailing the specific context of a given browser event, so that the agent 16 may more particularly determine the appropriate action or actions to take.

The agent 16 takes action in response to the event notification, based on the instructions contained in the corresponding event handler within the behavior file 28 (block 226). If the user elects to exit or close the browser 14 (block 228), the plug-in 15 notifies the agent 16 (block 230). If the user does not exit the browser 14, processing returns to a point where the plug-in 15 and agent 16 are ready to support further interaction between the web site and the user (block 218).

In handling the various events communicated by the plug-in 15, the agent 16 may exercise some or all of its various modules. For example, the user may click a particular link displayed by the browser 14 that causes the agent 16 to display predetermined web content via the viewer module 84, or may cause the agent 16 to generate sound effects or output speech using the sound effects module 78 and speech-to-text module 82. Overall, the agent 16 provides an enormously flexible interface for communicating with the user, and for enhancing the user's browsing experience. By configuring the behavior file 28 and the other supporting files 30, a web site operator can provide remote users with an interactive and supportive web browsing experience, provided those remote users have the agent 16 installed on their computers 12.

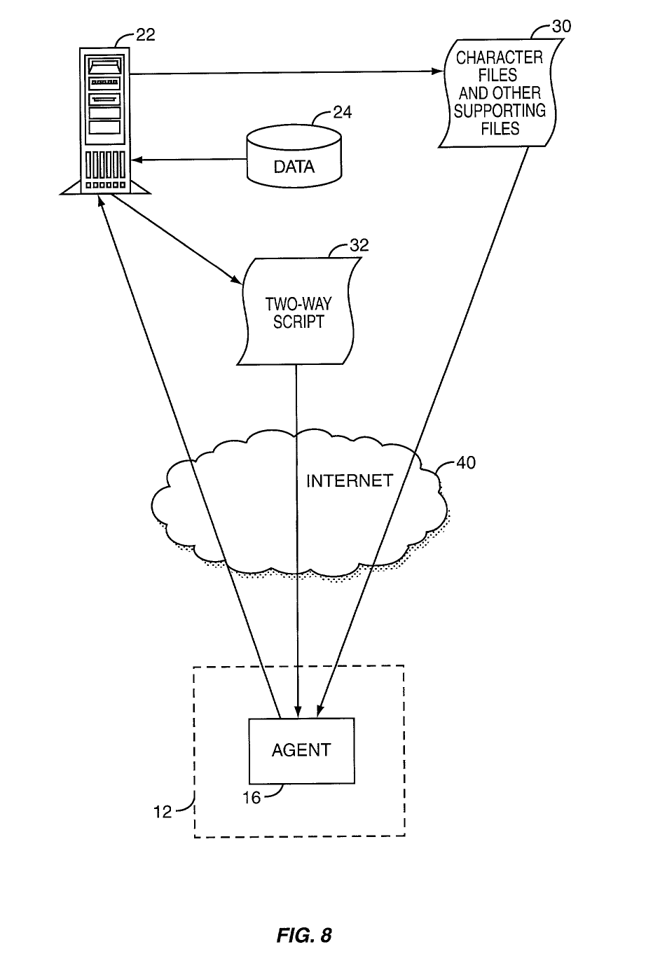

FIG. 8 is a diagram of the two-way service mode of the agent 16. In two-way service, the operation of the agent 16 is similar to the web service discussed above, in that the agent 16 requests remote files from the character server 22. More particularly, the agent 16 requests a two-way script 32 from the character server 22. The script 32 provides behavior information, perhaps in the form of a CAML document, to the agent 16. If the user is has the browser 14 active, it may request the two-way script 32 from the character server 22, or from the web server 18. In this case, the plug-in 15 may transfer or communicate the two-way script 32 to the agent 16.

If the agent 16 needs new or updated supporting files 30, such as character animation files, it downloads these from the character server 22. Both the script 32 and the other supporting files 30 may be stored in the database or storage unit 24 of the character server 22. Thereafter, the agent 16 plays sounds, character animations, displays text and menus, and provides other communication or interaction based on the user's interaction with it and on behavior information in the script 32.

One feature of the two-way service mode is that the agent 16 may automatically access one or more character servers 22 whenever there is a connection between the computer 12 and the Internet 40. For example, the agent 16 may remember addresses of previously accessed character servers 22, and contact one or more of these servers 22 once an Internet connection becomes available. Web site operators associated with these character servers 22 can then use the agent 16 as a way of providing new or updated information to the user, without relying on the user to actually visit the associated web sites.

Of course, the agent 16 may provide configuration settings to the user, allowing the user to determine whether such autonomous operation of the agent is permitted. The agent 16 may further permit the user to identify the particular character servers 22 from which the agent 16 is permitted to automatically retrieve information, and may also permit the user to configure what types of supporting files may be automatically retrieved. For example, as a matter of convenience, the user may wish to configure the agent 16 to automatically download only text information (e.g., supporting files for balloon text or custom menus), rather than active content for the viewer module 84, or large animation sequences for the character module 70.

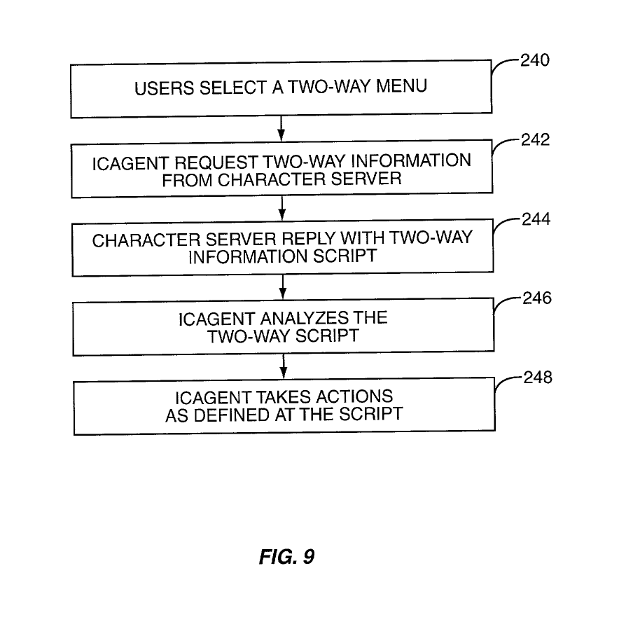

FIG. 9 is a diagram illustrating exemplary flow logic for the two-way service mode. Based on the user selecting an interactive menu selection provided by the agent 16, or based on the agent 16 automatically generating a request (block 240), the agent 16 requests a two-way script 32 from a character server 22 available via the Internet 40 (block 242).

The character server 22 replies with a two-way script 32 (block 244), which the agent 16 receives and analyzes (block 246). The agent 16 then operates based on the behavior information in the two-way script 32, such as playing specific character animation sequences using its character interface module 70 (block 248). The agent 16 may also interactively communicate user actions back to the character server 22 in accordance with behavior information defined by the two-way script 32.

The following text illustrates exemplary two-way script information in accordance with the earlier structural description of the CAML document format:

WebDog.Title (Today's weather in New York)

WebDog.Play (ANCHOR)

WebDog.Speak(OK Ryan, here's today's weather forecast for New York., NULL) WebDog.Present (http://210.69.50/demo/yahoo/twoway/weather/weather.html,0,dogskin03,1)

WebDog.Speak(As you might have noticed Ryan, it is windy and raining., NULL)

WebDog.Play (BLOW_NOSE)

WebDog.Speak(Be careful not to catch a cold like me., NULL)

WebDog.Play (GESTURE_RIGHT)

WebDog.Speak(If you want more detailed weather information, please click here., NULL)

WebDog.EndItem( )

In the example above, a two-way script instructs the agent 16 to provide the user of the computer 12 with an animated character named “WebDog” capable of providing one or more weather forecasts. In this implementation, the WebDog character performs several animated sequences, and provides the opportunity for intuitive user interaction.

For example, the “.Speak” entries in the above script instruct the agent 16 to play selected speech files via its text-to-speech module 82. Similarly, the WebDog character provided on the display 52 is animated by the character interface module 70 in accordance with the “.Play” script entries and the corresponding animation sequences in the supporting files 30. Also note that several functions may be tied into specific script instructions. For example, the “WebDog.Play(BLOW_NOSE) entry may be mapped into both an animation sequence as well as a sound effect output by the behavior file 28.

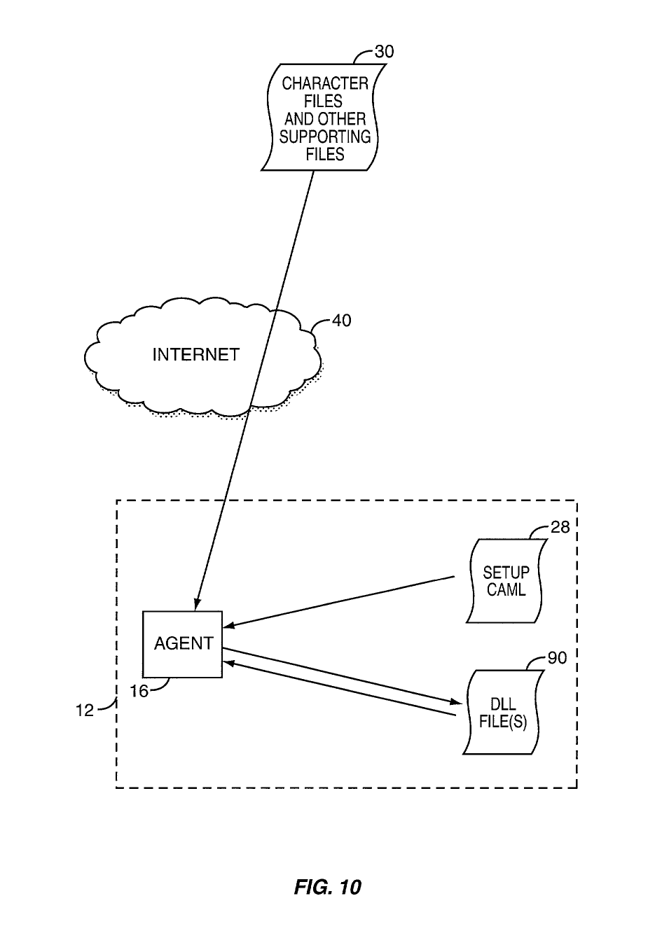

FIG. 10 is a diagram of the local service mode of the agent 16. In its local service mode, the agent 16 provides interactive support to the user independent of communications with a remote character server 22, or remote web server 18. Using its local server mode, the agent 16 can provide pre-constructed presentations to the user. Such presentations may relate to new or existing software packages, or might be provided as part of promotional campaign. In other cases, the presentations may relate to services or products associated with web sites previously visited by the user, or may include presentations included with the initial installation of the agent 16.

In any case, if the agent 16 requires new or updated animation sequences, or other supporting file information, it may download such information from a supporting character server 22 when an Internet connection becomes available. If the needed supporting file information is already locally available, the agent 16 need not communicate with any remote system.

Typically, the local information needed by the agent 16 comprises a locally stored behavior file 28, which may be CAML document. Further the agent 16 needs one or more of its modules (e.g., character interface module 70, menu module 74, balloon text module 76, etc.). The specific modules needed by the agent 16 depend upon the nature of the presentations it will run for the user. For example, if none of the presentations require voice input or output, the agent 16 may not include the voice recognition module 80 and the text-to-speech module 82. Other modules may be omitted or included as needed. As previously explained, some or all of these modules may be stored as supporting DLL files 90.

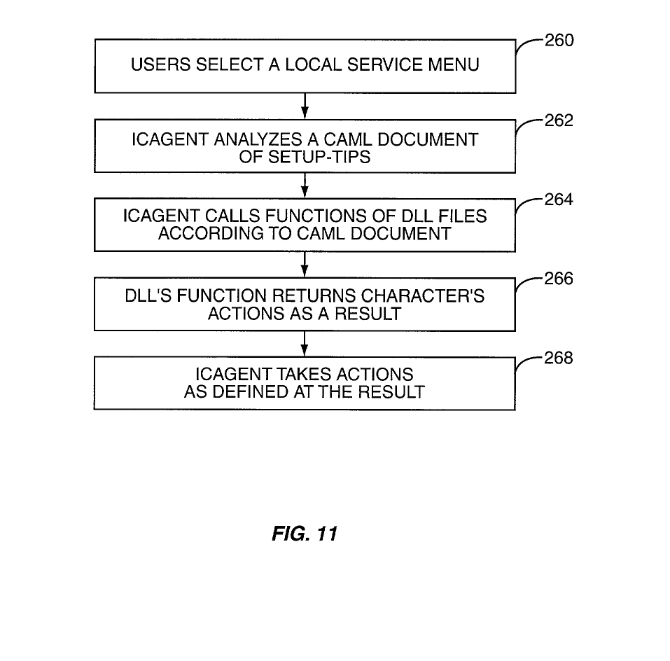

FIG. 11 is an exemplary logic flow diagram for the local service mode of the agent 16. Processing begins with the user selecting a local service menu, or otherwise interacting with the agent 16 in a manner that initiates local service interaction (block 260). The agent 16 access the locally stored behavior file (e.g., CAML setup document) (block 262), and then calls various functions supported by the DLL files 90, as needed (block 264). The DLL files 90 provide return results relevant to the functions executed (block 266), and the agent 16 provides those results, as appropriate, to the user (block 268).

For example, the user may select a particular menu item displayed on the display 52 in association with the menu module 74. In response to the user selecting the particular menu item, the agent 16 may call a supporting DLL file function that returns relevant information, such as help or support text, that the agent 16 may then display using its balloon text module 76, or output as speech using its text-to-speech module 82.

The actions taken by the agent 16 in this local service mode depend upon the user's specific interactions, such as particular menu item selections, as well as on the behavior information in the local behavior file. At various times, either automatically or under the user's direction, the local files, including the behavior file 28 and other supporting files 30 may be replaced or updated. For example, a supporting character server 22 may provide updated versions of these files for download by agents 16.

The DLL files 90 may essentially serve as “plug-ins” for one or more applications running on the computer 12. In this sense, the agent 16 may incorporate specific support for various software applications, and provide interactive support or guidance to the user while the user is running a supported application. Indeed, by adding DLL files 90, the agent 16 provides an extensible platform for supporting many different functions relevant to specific software packages or operating systems. For example, software manufacturers may include one or more custom DLL files 90 with their software that enable the agent 16 to support or otherwise enhance the use of their software on computers 12 that include the software for the agent 16.

Services provided by the agent 16 in its local service mode may include one or more character animations based on animation sequences contained in graphic files included with the supporting files 30. Selected animation sequences are displayed on the display 52 by the character interface module 70, depending on the user's actions, the current state of the related software running on the computer 12, and the related instructions in the behavior file 28. Of course, the agent 16 may also provide any or all of the services available in any of its other modes.

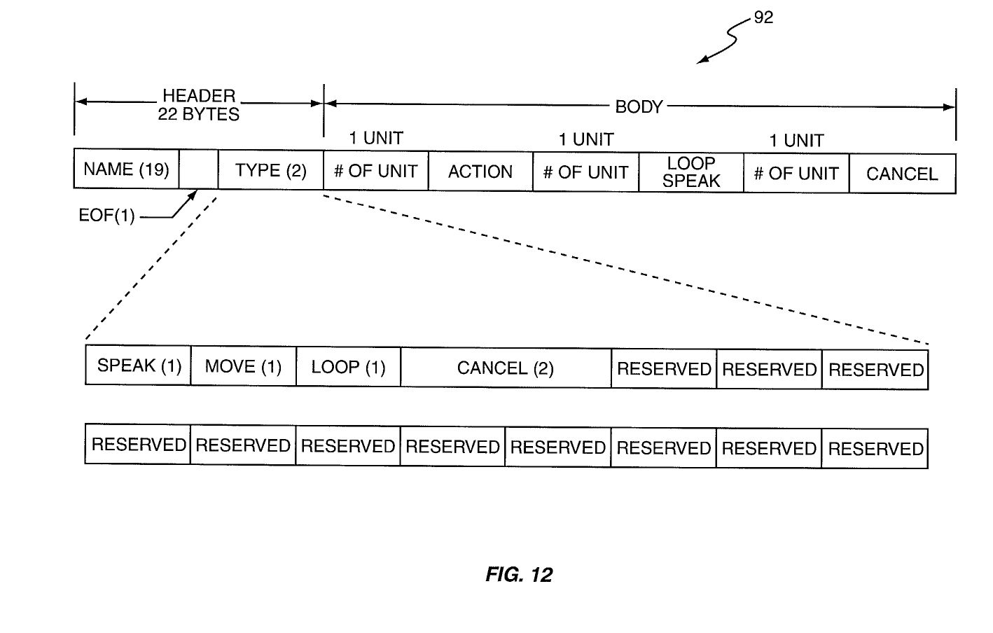

FIG. 12 is a diagram of an exemplary character file 92 that may be included as one of the supporting files 30, and used by the agent 16 to configure and control the animated character displayed by it. The character file 92 comprises HEAD and BODY blocks. The HEAD block contains names for the various animated actions supported by the character file, and provide the agent 16 with identifying the various animation sequences provided by the character file 92. The HEAD block may also contain or define other properties for the animated character, such as its default name, and also specifies the total number of graphic files (e.g., GIFs) comprising its various animation sequences.

The BODY block comprises the various animation sequences, which may simply comprise various sets of associated GIF files. The BODY block also includes region data for processing the transparency of the animated character's frame. The agent 16 may use this region data to determine specific display attributes for the animated character it provides on the display 52. The region data may include additional display control information.

Because of the inherent flexibility available with software-based systems, the agent 16 allows much variation regarding its implementation and operation. While the agent 16 may be based on one or more DLL files 90, it may also include an overall agent process that coordinates its general operation, and manages or cooperates with operation of the various DLL files 90 that provide it with specific functionality. The agent process may itself be a comprehensive software program, and may incorporate some of all of the agent functionality otherwise provided by the DLL files 90 (e.g., the supporting modules of the agent 16).

The present invention may, of course, be carried out in other specific ways than those herein set forth with departing from the scope and essential characteristics of the invention. Indeed, the present invention a flexible way to enhance communication and interaction with a user of a computer system. The present embodiments are therefore to be construed in all aspects as illustrative and not restrictive, and all changes coming within the meaning and equivalency of the appended claims are intended to be embraced herein.

What is claimed is:

1. A method of conveying information to a user of a computer, the method comprising:
providing an agent program at said computer, said agent program operative to animate a character on a display of said computer based on a graphic file defining an appearance of said character and a behavior file specifying desired control of said character;
retrieving by said agent program said graphic file and said behavior file from a remote character server via an Internet connection between said computer and said remote character server, said remote character server providing dedicated storage for said graphic file and said behavior file;
generating by said agent program said character for display to the user based on graphic information in said graphic file and controlling said character based on instructions in said behavior file to effect said desired control of said character, thereby conveying said information to the user of said computer.

2. The method of claim 1 wherein said instructions in said behavior file define an animated presentation to convey said information to the user, and said graphic file comprises at least one animation sequence supporting said animated presentation, and further comprising, by said agent program, animating said character to effect said animated presentation based on said instructions in said behavior file and said at least one animation sequence in said graphic file.

3. The method of claim 2 further comprising:
retrieving by said agent program audio information associated with said animated presentation from said remote character server; and
controlling by said agent program the playback of said audio information in conjunction with performing said animated presentation.

4. The method of claim 2 further comprising:
retrieving by said agent program informational text associated with said animated presentation from said remote character server; and
controlling by said agent program the display of said informational text in conjunction with performing said animated presentation.

5. The method of claim 2 further comprising:
retrieving by said agent program informational text associated with said animated presentation from said remote character server; and
controlling by said agent program the generation of speech output at said computer in conjunction with performing said animated presentation based on said informational text.

6. The method of claim 2 further comprising:
retrieving by said agent program streaming content associated with said animated presentation from a web server associated with said remote character server; and
controlling by said agent program the display of a video component of said streaming content to a screen viewer provided by said agent program.

7. The method of claim 1 further comprising:
retrieving by said agent program from said remote character server menu information associated with said behavior file;
displaying a menu in conjunction with said character on said display of said computer based on said menu information, said menu information defining at least one menu selection;
monitoring for a selection action by the user directed at said menu; and
by said agent program, responding to said selection action based on control instructions in said behavior file corresponding to a selected one of said at least one menu items of said menu.

8. The method of claim 1 wherein said agent program comprises a number of functional modules including a character interface module to control said character, and at least one of a set of additional functional modules, said set of additional functional modules comprising a speech recognition module, a text-to-speech module, a streaming content viewer module, a sound effects module, a menu module, and a text balloon module.

9. The method of claim 1 further comprising:
providing a browser-associated program to receive selected information from a web browser program active on said computer;
recognizing via said browser-associated program when the browser program receives web page information from a web site indicating support for said agent program;
notifying said agent program via said browser-associated program that a current web page has at least one associated behavior file and graphic file;
retrieving by said agent program said at least one associated behavior file and graphic file from a dedicated character server associated with said web site in response to receiving notice from said browser-associated program; and
performing by said agent program an initial information presentation to the user via at least said character on said display based on said at least one associated behavior file and graphic file.

10. The method of claim 9 further comprising:
notifying via said browser-associated program said agent program of browser events related to said web site;
determining by said agent program if said behavior file defines a desired action corresponding to a given browser event; and
performing by said agent program said desired action, if said desired action is defined in said behavior file for the given event.

11. The method of claim 10 further comprising:
retrieving by said agent program at least one additional supporting file from said remote character server, said additional supporting files comprising at least one of a menu file, a viewer file, a text output file, a speech output file, and a sound effects file; and
providing additional informational output to the user of said computer as part of said desired action based on information in said at least one additional supporting file.

12. The method of claim 9 wherein notifying said agent program via said browser-associated program that a current web page has at least one associated behavior file and graphic file comprises providing an address of said remote character server to said agent program.

13. The method of claim 1 wherein said behavior file comprises a two-way script file, the method further comprising:
performing at least one desired action defined in the two-way script file;
monitoring for a user input to the computer system associated with said character;
determining a desired response to the user input based on information in the two-way script file;
retrieving additional supporting information from said remote character server if necessary to support said desired response; and
performing by said agent program said desired response based on information in the two-way script and any additional supporting information retrieved from said remote character server.

14. The method of claim 1 wherein retrieving by said agent program said graphic file and said behavior file from a remote character server via an Internet connection between said computer and said remote character server, said remote character server providing dedicated storage for said graphic file and said behavior file comprises retrieving a character action markup language (CAML) file as said behavior file.

15. The method of claim 1 wherein retrieving by said agent program said graphic file and said behavior file from a remote character server via an Internet connection between said computer and said remote character server, said remote character server providing dedicated storage for said graphic file and said behavior file comprises retrieving graphical information defining at least one desired animation sequence as said graphic file.

16. A method of conveying information to a user of a computer system, the method comprising:
accessing a web page using a web browser running on the computer system, said web page containing notification that said web page is associated with a remote character server providing dedicated storage for supporting files associated with said information to be conveyed to the user;
notifying an agent program available on the computer system via a browser-associated program responsive to said notification in said web page;
retrieving by said agent program said supporting files from said character server in response to receiving said notification from said browser-associated program; and
providing a presentation under control of said agent program to the user of the computer system to convey said information based on generating a character as defined by a graphic file on a display of the computer system and controlling said character in accordance with instructions for said agent program contained in a behavior file;
said behavior file and said graphic retrieved from said remote character server by said agent program as part of said supporting files.

17. The method of claim 16 further comprising:
notifying said agent program via said browser-associated program of user events associated with the web page displayed by the web browser;
responding to notification of a given event by said agent program by determining whether said behavior file defines a desired action corresponding to said given event; and
performing said desired action by said agent program in response to said notification if said desired action is defined for said given event in said behavior file.

18. The method of claim 17 wherein performing said desired action by said agent program in response to said notification if said desired action is defined for said given event in said behavior file comprises performing a subsequent presentation specifically keyed to said given event.

19. The method of claim 17 further comprising:
retrieving at least one additional supporting file from said remote character server if necessary to support said desired action; and
using said at least one additional supporting file retrieved from said remote character server by said agent program to support performance of said desired action.

20. The method of claim 16 wherein providing a presentation under control of said agent program to the user of the computer system to convey said information based on generating a character as defined by a graphic file on a display of the computer system and controlling said character in accordance with instructions for said agent program contained in a behavior file comprises performing a desired animation sequence identified in said behavior file to animate said character.

21. The method of claim 16 further comprising generating audio information in conjunction with providing said performance.

22. The method of claim 21 further comprising retrieving via said agent program data bearing on said audio information from said remote character server.

23. The method of claim 16 further comprising generating at least one word balloon containing informational text in conjunction with providing said performance.

24. The method of claim 23 further comprising retrieving via said agent program data bearing on said informational text from said remote character server.

25. The method of claim 16 further comprising generating at least one word balloon containing informational text in conjunction with providing said performance.

26. The method of claim 25 further comprising retrieving via said agent program data bearing on said informational text from said remote character server.

27. The method of claim 16 further comprising outputting streaming media content in conjunction with providing said performance.

28. The method of claim 27 further comprising retrieving via said agent program data bearing on said streaming media content from said remote character server.

29. The method of claim 16 further comprising generating speech output conjunction with providing said performance.

30. The method of claim 29 further comprising retrieving via said agent program data bearing on said speech output from said remote character server.

31. The method of claim 16 further comprising generating at least one user menu in conjunction with providing said performance.

32. The method of claim 31 further comprising retrieving via said agent program data bearing on said user menu from said remote character server.

33. The method of claim 31 further comprising responding via said agent program to user input selections directed at said user menu based on instructions in said behavior file.

34. A computer readable media comprising software for instructing a computer system to:
determine if said computer system has an active connection with the Internet;
establish communications with a remote character server providing dedicated storage for a behavior file and a supporting graphic file;
retrieve said behavior file and said supporting graphic file from said remote character server;
display a character on a display of said computer system based on graphical information in said supporting graphic file; and
control said character to convey information to a user of said computer system based on said behavior file.

35. The computer readable media comprising software of claim 34 to further instruct the computer system to:
retrieve at least one additional supporting file from said remote character server, said at least one additional supporting file associated with said behavior file; and
output additional information to the user based on information in said at least one additional supporting file in association with controlling said character based on said behavior file;
wherein said at least one additional supporting file comprises at least one of a sound effects file, a text output file, a speech output file, a menu file, and a viewer file.

36. The computer readable media comprising software of claim 35 to further instruct said software to work with at least one supporting service available on the computer system to effect control of said character and output of said additional information.

37. The computer readable media comprising software of claim 36 wherein further instructing said software to work with at least one supporting service available on the computer system to effect control of said character and output of said additional information comprises instructions to effect control of said character using display services available via an operating system available on the computer system.

38. The computer readable media comprising software of claim 36 wherein further instructing said software to work with at least one supporting service available on the computer system to effect control of said character and output of said additional information comprises instructions to effect the output of audio information using audio services available via an operating system available on the computer system.

39. The computer readable media comprising software of claim 36 wherein further instructing said software to work with at least one supporting service available on the computer system to effect control of said character and output of said additional information comprises instructions to effect the output of electronic speech using audio services available via an operating system available on the computer system.

40. The computer readable media comprising software of claim 36 wherein further instructing said software to work with at least one supporting service available on the computer system to effect control of said character and output of said additional information comprises instructions to effect recognition of input speech by the user using speech recognition features available via an operating system available on the computer system.

41. The computer readable media comprising software of claim 34 to further instruct the computer system to:
generate a notification that a web page accessed by a browser program active on the computer system is associated with a specified behavior file and graphic file;
retrieve said specified behavior file and graphic file from a remote character server specified as part of said notification; and
control said character based on said specified behavior file and graphic file retrieved from said remote character server specified as part said notification.

42. The computer readable media comprising software of claim 41 to further instruct the computer system to:
generate event notices in response to user input events directed to the web page displayed by the browser program;
determine whether said specified behavior file defines a desired action for a given event notice; and
performing said desired action if defined by said specified behavior file.

43. The computer readable media comprising software of claim 42 to further instruct the computer system to retrieve any additional supporting files from said remote character server necessary to support performance of said desired action, said additional supporting files comprising at least one of an additional graphic file, a sound effects file, a text output file, a menu file, a speech output file, a viewer file.

44. The computer readable media comprising software of claim 34 wherein said software comprises at least one program module, said at least one module operative to instruct the computer system to display and control said character on the display of the computer system based on said graphic file in accordance with instructions in said behavior file.

45. The computer readable media comprising software of claim 44 wherein said software comprises at least one additional program module to instruct the computer system to display word balloons containing informational text in association with said character.

46. The computer readable media comprising software of claim 44 wherein said software comprises at least one additional program module to instruct the computer system to display user menus in association with said character.

47. The computer readable media comprising software of claim 46 wherein said at least one additional program module further instructs the computer system to respond to menu selection inputs by the user directed to said user menus based on instructions in said behavior file corresponding to said user menus.

48. The computer readable media comprising software of claim 44 wherein said software comprises at least one additional program module to instruct the computer system to output streaming content in association with said character.

49. The computer readable media comprising software of claim 44 wherein said software comprises at least one additional program module to instruct the computer system to output audible speech in association with said character.

50. The computer readable media comprising software of claim 44 wherein said software comprises at least one additional program module to instruct the computer system to recognize input speech from the user.

51. The computer readable media comprising software of claim 50 wherein said at least one additional module instructs the computer system to initiate a desired action in response to recognizing an input command received via said input speech, if said input command has a desired action defined in said behavior file.

52. The computer readable media comprising software of claim 34 wherein said software comprises a plurality of software modules, each said module directed to providing a specific type of functionality.

53. The computer readable media comprising software of claim 52 wherein said plurality of modules is organized as a plurality of dynamic link library (DLL) files.
